(19) United States
(12) Patent Application Publication
(10) Pub. No.: US 2011/0035956 A1
(43) Pub. Date: Feb. 17, 2011

(54) TREATMENT OF ORGANIC MATTER

(76) Inventors: Michael Morris-Watson, Kirton Suffolk (GB); Adrian Ramsey, Kesgrave Suffolk (GB); Duncan Foster, Woodbridge Suffolk (GB)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/595,903

(22) PCT Filed: Apr. 21, 2008
(86) PCT No.: PCT/GB08/50276

§ 371 Date: Nov. 1, 2010

(30) Foreign Application Priority Data
Apr. 21, 2007 (GB) 0707750.6

(51) Int. Cl. F26B 5/06

(52) U.S. Cl. 34/287; 34/92

(57) ABSTRACT

A method for treatment of organic matter, and inorganic matter that has been biologically contaminated, such as human cadavers, animal carcasses and clinical waste, to prepare the matter for burial or other disposal is disclosed. The method involves freeze-drying the size-reduced organic matter whilst subjecting the partially-dehydrated remains to a series of vacuum-pressure cycles. Process conditions are chosen so as to favour microbial inactivation.

### FIELD OF THE INVENTION

The invention relates to methods and apparatus for treating wet organic matter, or inorganic matter that has been biologically contaminated. In particular, it relates to methods for preparing such material, such as human and animal remains and clinical waste, for disposal by burial, and to allow the sanitised inorganic matter to be sorted and recycled.

### BACKGROUND AND PRIOR ART KNOWN TO THE APPLICANT

At present, cremation is the main process for the disposal of large animal carcasses and is often used for the disposal of bodies of dead humans. The process uses large quantities of fossil fuels and results in the discharge of large volumes of carbon dioxide to the atmosphere. This clearly has negative environmental consequences in relation to atmospheric CO₂. The other common method of disposal of such organic material is burial, and in the context of disposal of animal waste, often mass burial. This process has, however, possible negative consequences for soil contamination, and damage to watercourses especially from mass animal burial sites.

Despite the high energy demand of the cremation process, burning of such animal remains has the advantage of killing any pathogens within the bodies, so preventing microbial contamination of the ground in which the ashes may be deposited. Such pathogens occur naturally in the digestive tract of animals, but particular pathogens may also be present in the material such as those that led to the death of the animal or person concerned. For example, if a person dies from septicaemia, their blood will contain high titres of human pathogens. Similarly, if a farm animal dies from a disease such as Foot and Mouth Disease or Bovine Spongiform Encephalopathy (BSE) the carcass would be potentially contaminated respectively with the virus or prion responsible for these diseases.

Alternative processes have been proposed, such as that described in international patent application WO 0140727 in which liquid nitrogen is used to freeze a body prior to mechanical disintegration, and subsequent drying. However, it is well known that liquid nitrogen freezing can actually act to preserve bacteria and other organisms.

It is an object of the invention, therefore, to provide alternative methods for disposal of animal and human bodies using lower energy input, and resulting in a microbiologically acceptable material.

### SUMMARY OF THE INVENTION

Accordingly, in a first aspect the invention provides a method of treating organic remains comprising the steps of: (a) freezing said remains to a temperature of below −180° Celsius; (b) size-reducing said remains to produce a size-reduced fraction having a particle size of less than 10 mm; (c) exposing said frozen size-reduced fraction to a partial vacuum, having a pressure of below 1 kPa; (d) heating said size-reduced fraction in said partial vacuum, removing water therefrom; (e) releasing said partial vacuum; and (f) repeating steps (c) to (e). In some embodiments, steps (c) to (e) may be repeated once (i.e. carried out twice), but in particularly preferred embodiments, the steps (c) to (e) are repeated twice, or even more times—the inventors have found considerable improvement to bacterial inactivation when the steps are carried out three times, or more.

Preferably, said partial vacuum has a pressure of below 0.1 kPa. Again, the inventors have found that such lower pressures increase microbial kill, and enhance drying of the remains.

In any aspect of the invention, it is further preferred that, in step (d), said fraction is heated to a temperature above 50° Celsius. The inventors have found that the use of such a temperature surrounding the frozen remains enhances the microbial inactivation. More preferably, said fraction is heated to a temperature of between 50° and 60° Celsius. This range provides a good balance between microbial inactivation, energy input, and efficient removal of water from the remains.

In any aspect of the invention it is also preferred that, having released said partial vacuum at step (e), said remains are held at such increased pressure for at least 5 minutes before re-exposure to partial vacuum. During this pressure release phase, it is believed that heat is transferred to the remains by condensation of water vapour, so contributing to the microbial inactivation.

In any aspect of the invention it is also preferred that the size reduction of step (b) produces a particle size of less than 2 mm. Preferably, the particles are predominantly of a particle size of between 1-2 mm. The inventors have found that this size leads to efficient drying of the remains.

In some applications, for example the treatment of the remains of deceased humans, the organic matter may contain non-organic matter such as metals, ceramics and plastics. This might have the form e.g. of artificial replacement joints, heart pacemakers and the like. In order that the remains treated by methods disclosed herein may be conveniently be buried in soil, without causing environmental contamination, the invention also provides a method for treating organic remains containing non-organic material comprising a method according to any preceding claim preceded by further steps of: (i) freezing said remains to a temperature of below −40° Celsius; (ii) size-reducing said remains to produce a coarsely-size-reduced fraction having a size of less than 100 mm; and (iii) removing non-organic material from said coarsely-size-reduced fraction.

Also included within the scope of the invention is a method of treating organic remains substantially as described herein, with reference to and as illustrated by any appropriate combination of the accompanying drawings.

Also included within the scope of the invention is a method of disposing of human cadavers comprising the steps of treating the cadavers by a method described herein.

Preferably, the method further comprises the step of adding a high-carbon, low nitrogen complex polysaccharide to said treated cadavers, and allowing said mixture to decompose.

Further included within the scope of the invention is apparatus configured to carry out a method described herein.

In a further aspect, the invention also provides a method of treating organic remains comprising the steps of: freezing said organic remains to a temperature of below −180° Celsius; fracturing the frozen remains to produce size-reduced frozen remains; size-separating the size-reduced frozen remains to produce a fine fraction and a coarse fraction; subliming water from the fine fraction to produce treated remains; and repeating the method on material from the coarse fraction.

The invention also provides a method of treating organic remains comprising the steps of: freezing said organic remains to a temperature of below −180° Celsius; subliming water from the frozen remains to produced dried frozen remains; fracturing said dried frozen remains to produced size-reduced dried frozen remains; size-separating the size-reduced dried frozen remains to produce a fine fraction of treated remains and a coarse fraction; and repeating the method on material from the coarse fraction.

In any method, it is preferred that freezing is carried out using liquefied gas.

Also in any method, it is preferred that the treated remains are further sterilized.

Also in any method, it is preferred that the freezing stage is controlled to favour the inactivation or destruction of microbial pathogens. Preferably, the freezing stage is controlled to favour ice crystal growth.

Also in any method, it is preferred that the sublimation stage is controlled to favour the inactivation or destruction of microbial pathogens.

Also included within the scope of the invention is a method of treating organic remains substantially as described herein, with reference to and as illustrated by any appropriate combination of the accompanying drawings.

### BRIEF DESCRIPTION OF THE DRAWINGS

The invention will be described with reference to the accompanying drawings, in which:

FIG. 1 is a schematic diagram of a method according to the present invention;

FIGS. 2 and 3 are respectively cross-sectional and perspective views of size reduction apparatus of use in methods of the present invention;

FIG. 4 is a graphs showing pressure variation during freeze-drying cycles of a method of the present invention; and

FIG. 5 is a schematic diagram of a further method according to the present invention.

### DESCRIPTION OF PREFERRED EMBODIMENTS

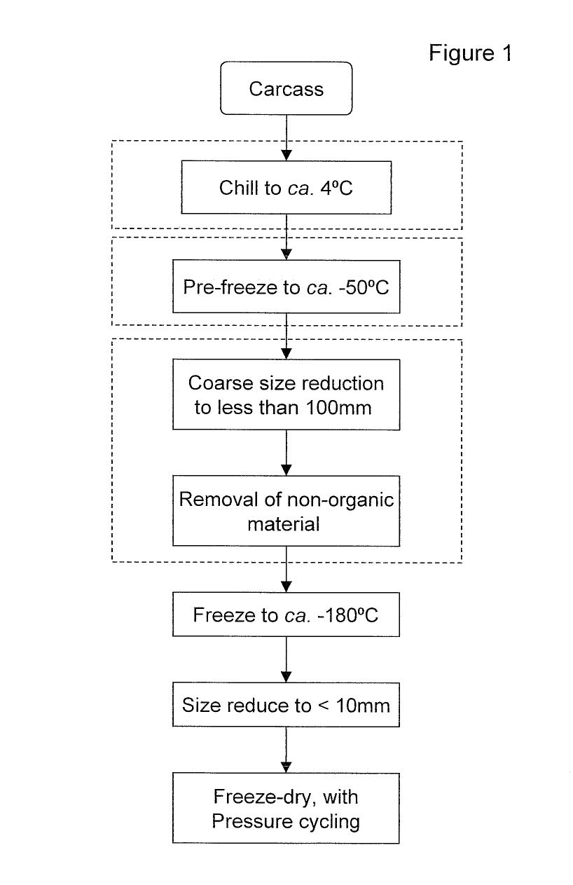

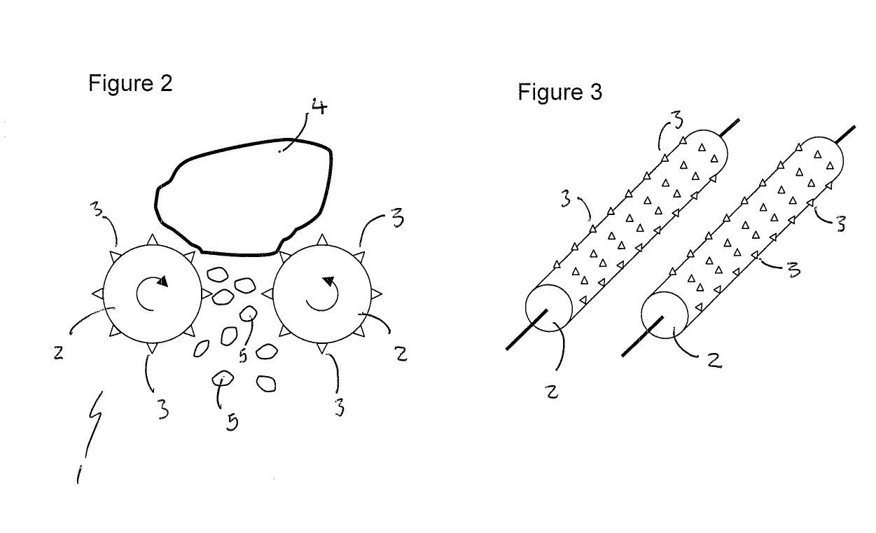

FIG. 1 is a schematic flow diagram of a method for treating organic remains according to the present invention. Process stages contained within dotted outline boxes are optional. In a typical embodiment of the process, an animal carcass, or a body of a deceased person, would be chilled to approximately 4° C., to prevent further degradation and decomposition of the remains. At an appropriate time, the remains would be pre-frozen to approximately −50° C. and subjected to a size reduction process to produce fragments of approximately 50-100 mm in size. The inventors have found that pre-freezing the remains in this way assists in the size reduction process, and subsequent processing. Size reduction may be carried by the of a rotating blade assembly, and a particularly suitable apparatus is described below with reference to FIGS. 2 and 3. For the treatment of human remains, this coarse size reduction allows access to non-organic material contained with the body, such as artificial joints, pacemakers and the like. These can them be removed for recycling prior to further processing of the remains.

The coarsely-size-reduced remains are then frozen to cryogenic temperatures, of approximately less than −180° C. by the use of e.g. liquid nitrogen. The remains are then further size-reduced at low temperature, producing particles of remains of approximately less than 10 mm in dimension. The inventors have found that further benefits accrue in later stages of processing from a size reduction producing particles of between 5-10 mm, or even less than 2 mm. Appropriate apparatus for such further size reduction include mills, such as ball mills, or rotating blade and screen arrangements.

Following this fine size reduction, the still frozen particles are introduced into freeze-drying apparatus. Such apparatus can comprise a series of trays within a freeze-drying chamber, or apparatus in which the material is constantly stirred during drying. The pressure within the freeze drying chamber is reduced to less than 1 kPa, or more preferably to less than 0.1 kPa, and heat applied to increase the temperature surrounding the frozen remains to initiate sublimation of the water within the remains. The inventors have found that a temperature of above 50° C. is particularly effective. After a period of drying, for say 1 hour, the partial vacuum is released from the drying chamber, and the remains held at the higher pressure (which may conveniently be atmospheric pressure). This period of higher pressure may be for a short time, of the order of a minute, or more preferably for a longer period of at least five minutes. The inventors have found that holding the partially-dehydrated remains at the higher pressure for this extended period of time results in a greater reduction of the bacterial load.

The freeze drying chamber is then evacuated once more, to a pressure of less than 1 kPa, and further drying carried out. The inventors have found that the use of successive vacuum-pressure cycles results in considerably greater reduction in microbial load than freeze-drying alone; indicative experimental results are presented below. The inventors have also found that if the pressure cycles are carried out after the moisture content of the remains has reduced to below approximately 25% (w/w), then additional microbicidal effect is observed. At least two such vacuum-pressure cycles are preferred, and more preferably three or more such cycles are employed.

Where a tray-type freeze drying apparatus is employed, further benefits ensue: firstly, successive trays may be introduced and/or removed from the drying chamber during the effectively atmospheric pressure phase of the drying operation, so allowing an otherwise batch process to be operated in semi-continuous mode. Secondly, remains from individuals can be maintained separate, allowing the dehydrated remains to be treated and further processed separately—an important factor for human remains.

FIG. 2 illustrates, in cross-sectional view, apparatus, generally indicated by 1, for carrying out an initial size reduction operation on the frozen remains. The apparatus comprises counter-rotating shafts 2, on the surface of which are located an array of cutting elements 3. The frozen remains 4 are loaded onto the top of the rotating shafts 2, and the cutting elements 3 serve to reduce the remains to smaller pieces 5, of approximately 50-100 mm. The rotating shafts are positioned at a distance apart from each other to achieve this fragment size such that non-organic inclusions in the body (such as replacement hip joints) do not foul the cutters, and may be conveniently removed from the comminuted remains.

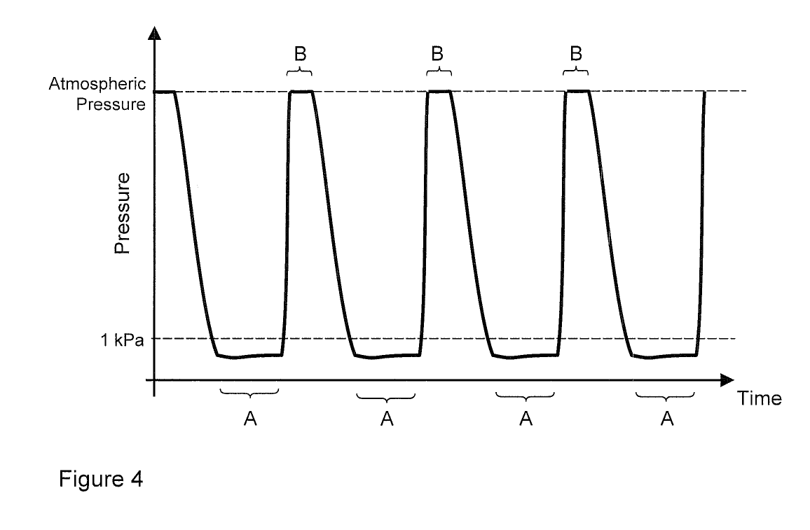

FIG. 4 illustrates, graphically, the pressure profile within a freeze-drying chamber during the dehydration process. Initially at atmospheric pressure, the chamber is evacuated to a pressure of below 1 kPa, and held for a drying period “A”, during which period heat is applied as described above. The vacuum is then released, and the partially-dehydrated remains held at atmospheric pressure for a dwell period “B”, during which time tray may be removed, or introduced into the chamber. The length of each successive drying period A or dwell period B may be adjusted to meet process and product requirements, and particularly preferred period durations are disclosed herein.

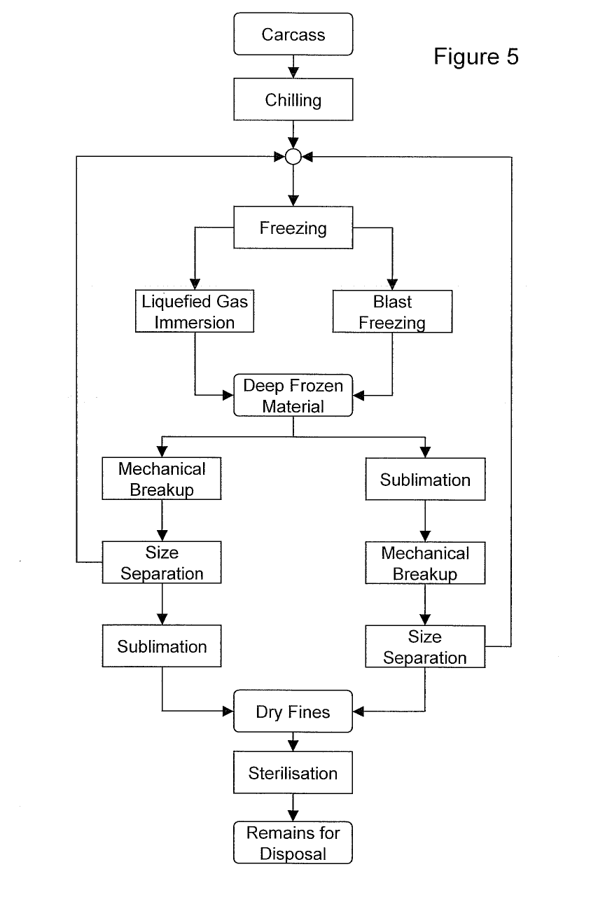

FIG. 5 is a schematic flow diagram of methods for treating organic remains according to the present invention. For clarity, we refer to the organic matter to be treated as a carcass, and in the broadest embodiment this could comprise human remains, or parts thereof, animal remains, or parts thereof, or clinical waste such as that produced by hospitals. In especially preferred embodiments, the term should be taken to comprise any of these categories individually.

As an initial step in the process, the carcass is chilled, typically to around 4° C. There then follows a freezing process to render the material in a deep frozen state, preferably in a temperature of below −180° C. At this temperature, the material becomes brittle. The freezing process may be accomplished by immersion of the carcass in liquefied gas, or by blast freezing, again preferably using a liquefied gas. Liquid nitrogen, having a temperature of approximately −196° Celsius, is particularly appropriate, although the use of other liquefied gases is envisaged.

Following such freezing, two alternative routes for processing are envisaged:

In a first route, the deep frozen carcass is subjected to a size-reduction process involving mechanical break-up of the deep frozen carcass to produce size-reduced frozen remains. In one process, the carcass is frozen by immersion in liquid nitrogen, contained within a suitably sized insulated vessel. After freezing, the carcass is lifted out of the liquid nitrogen by lifting means such as a scissor-type jack or raisable platform. Once out of the liquid nitrogen, the carcass may be subjected to mechanical shocks, for example by direct impact, or by cutting.

It is especially preferred to produce a fine fraction of disintegrated material having a size of below 10 mm, preferably in the range of 2-5 mm, and most preferably below 2 mm, to aid the subsequent drying process, to be described below. Therefore, remaining portions of the carcass, or those fractured portions falling outside this desired size range may be recycled and subjected to further freezing and size reduction processes. After preliminary fragmentation of a carcass it is envisaged that a portion of this larger material might be further size-reduced by use of e.g. cryogenic milling.

The size-reduced fractions of deep frozen material are then subjected to vacuum drying in order to remove most of the moisture they contain. Gentle heating of the frozen fractions under vacuum causes the water to sublime leaving a dry, readily fracturable material suitable for subsequent disposal. The application of heat during this vacuum drying process may preferably be adjusted to bring the material to be treated up to a temperature of 50-60° C.; this temperature, in combination with other factors to be discussed below, leads to an increase in the desired microbial inactivation.

In order to further enhance the microbicidal action of the process, a number of other process parameters may be manipulated. During the vacuum drying process, it is particularly preferred that the degree of vacuum employed (i.e. the pressure) is cycled or pulsed periodically. Furthermore, subjecting the carcass to a number of freeze-thaw cycles leads to increased ice crystal growth within the carcass, and subsequent microbial inactivation.

In a second route, deep frozen material produced as described above is subjected initially to a vacuum drying process as described, before size reduction by the various means already discussed. This size reduction process might also take the form of removing an outer dried layer of material from the carcass, leaving an inner core that still contains some water. This unfragmented core can then be recycled through the freezing process until all the material is reduced to the required size.

Inactivation of Bacteria

One of the key requirements of treatment regimes described herein for the treatment of organic remains such as cadavers and carcasses is the inactivation of micro-organisms, particularly bacteria, by the treatment process. In order to evaluate preferred operating conditions, a set of experiments to determine the ability of microbes to survive environmental stress related to freeze-drying were carried out. A first set of trial regarded a bacterial suspension of Escherichia coli, cultured in standard Nutrient Broth (henceforth NB) liquid medium until the stationary growth phase had been reached. Detection of surviving micro-organisms has been observed by plate spreading of 100 microlitres of bacterial suspension on the same medium with the addition of 1.5% agar. The suspensions were frozen by dipping them in liquid nitrogen for 1 minute.

Samples of the organisms were either frozen by dipping them into liquid nitrogen for 1 minute, or subjected to sonication by standard laboratory equipment used in microbiology laboratory cell disruption has been assessed as sonication is considered to be a efficient cell disrupting method. For the sonication of the E. coli cultures, three cycles of 30 s were used.

Viable counts of E. coli after treatment were 9.07×10⁶ colony forming units (cfu) per ml for the frozen sample and 6.68×10⁶ cfu/ml for the sonicated sample, compared to 9.83×10⁷ cfu/ml for the untreated control organisms. An approximate 10-fold reduction of viable microrganisms was therefore detected both after freezing and sonication.

As organisms are likely to be present in a matrix of organic material, that might lend some protection to the organisms, a further set of experiments was carried out with organisms being treated on a matrix of meat. Treatments included freezing, freeze-drying, and heating:

One ml of E. coli suspension in NB, grown to late logarithmic phase was used to inoculate 1 g of minced pork meat. The suspension was allowed to colonise the meat for 1 hour at 37° C. with orbital shaking (180 rpm). The samples were then frozen as indicated above. Thawing was carried out at room temperature until complete. Freeze-drying was carried out for 24 h at room temperature and 0.1 mTorr. Heating at 60° C. for 12 h served as a control.

Results of this series of experiments were as follows:

| | Microbial Count after |
|---|---|
| Treatment | Treatment (cfu/ml) |
| Inoculated Control | 1.39 × 10⁷ |
| Freezing | 1.05 × 10⁶ |
| Freeze-Thawing (2 cycles) | 8.47 × 10⁴ |
| Freeze-Thawing (3 cycles) | 6.33 × 10⁴ |
| Freezing and heating (12 h) | n.d. |

It can be seen that the effect of freezing was similar to that observed by freezing suspension of E. coli. A stronger effect was observed for freeze-drying, and a reduction of over 100-fold was recorded when 2 to 3 freeze-thawing cycles were applied.

A third and fourth set of trials were used to establish the effect of a range of freeze-drying conditions on four different microrganisms: Bacillus subtilis, a Gram Positive spore-forming bacterium, Escherichia coli, a Gram Negative non-spore former, Pseudomonas aeruginosa a Gram Negative aerobe and Staphylococcus aureus, a Gram Positive pathogen were used as test organisms representative of the flora likely to be found in carcasses and cadavers. Suspensions of the organisms were grown in Nutrient Broth, and inoculated onto a meat matrix as previously described.

| | Treatment: | | | |
|---|---|---|---|---|
| | | | | 6 h |
| | | | 72 h | 70° C. |
| | | 20 h | 80° C. | 2500 mTorr |
| | Untreated | 50° C. | 2500 mTorr | 3 pressure |
| Organism | control | 25 Torr | 2 pressure pulses* | pulses |
| B. subtilis | 5.8 × 10⁶ | d.n.s. | 5.0 × 10⁴ | 3.2 × 10⁵ |
| E. coli | 2.3 × 10⁸ | 4.0 × 10⁶ | n.d. | 1.2 × 10⁵ |
| Ps. aeruginosa | 1.3 × 10⁸ | 1.3 × 10⁸ | n.d. | 2.9 × 10⁴ |
| S. aureus | 7.8 × 10⁸ | 1.7 × 10⁶ | 3.7 × 10⁵ | 1.5 × 10⁶ |
| control | 1.6 × 10⁶ | d.n.s. | n.d. | 2.0 × 10¹ |

*indicates a release of vacuum for a period of 20 minutes.

| | Treatment: | | | |
|---|---|---|---|---|
| | | | 12 h | 6 h |
| | | | 60° C. | 60° C. |
| | | 8 h | 2500 mTorr | 2500 mTorr |
| | Untreated | 70° C. | 2 pressure | 3 pressure |
| Organism | control | 2500 mTorr | pulses* | pulses |
| B. subtilis | 1.5 × 10⁶ | d.n.s. | 2.55 × 10⁵ | 1.05 × 10² |
| E. coli | 4.16 × 10⁷ | 7.05 × 10⁵ | 1.5 × 10⁴ | 5.45 × 10² |
| Ps. aeruginosa | 4.23 × 10⁶ | 6.68 × 10⁶ | 8.23 × 10³ | n.d. |
| S. aureus | 2.72 × 10⁸ | 4.85 × 10⁷ | 8.9 × 10⁵ | 1.05 × 10² |
| control | n.d. | n.d. | 1.0 × 10³ | n.d. |

*indicates a release of vacuum for a period of 20 minutes.

The labels d.n.s. and n.d. indicate “data not shown” (data could not be retrieved due to contaminations and are therefore not significant) and “non detectable” (viable count was below the detection level of 1000 cfu/g).

It can be seen from the data, that considerable further inactivation of the bateria is achieved by use of such pressure pulses, i.e. releasing the vacuum between periods of vacuum drying. Three such pressure cycles provide significantly more inactivation of the organisms.

A yet further series of experiments, to demonstrate the applicability of the methods to whole bodies, was carried out:

Legs of pork meat, each weighing 8-9.5 kg were inoculated with a saline suspension of either Staphylococcus aureus or Bacillus subtilus. Approximately 20 ml of suspension was injected into the legs, at 20 different locations. Each leg was passed through a pre-breaker, and then frozen in liquid nitrogen. The frozen material was then loaded into a grinder, and broken onto smaller pieces (0.5 mm-1 mm in diameter). This frozen material was then loaded into a freeze dryer. Samples were taken (2.5 g meat+10 ml saline) after inoculation, and before treating with liquid nitrogen (BTWLN); after grinding (T₀), after 4 hours (T₄); and after 6 hours (T₆) freeze drying. In the tables that follow, sampling times are denoted generally by Tₙ, indicating sampling after n hours. At each sampling time, the pressure was released in the freeze dryer, to mimic the pressure cycling of the present invention. Unless stated otherwise, the pressure was released for approximately one minute. The moisture content of the meat was determined at each sampling point, and the pressure within the freeze dryer immediately preceding vacuum release was noted. Pressures are given in millibar (1 mbar=0.1 kPa).

The results were as follows:

TABLE 1
S. aureus population, moisture content and pressure at 60° C.
within 6 hrs of freeze drying

| | Dilutions: | | | | |
|---|---|---|---|---|---|
| | | Count | | | |
| | *Count | at 10⁻⁵ | | | |
| | at | dilution | **Log | | |
| | 10⁻⁴ | (Average ± | c.f.u./g of | Moisture | Pressure |
| Sample point | dilution | SD) | meat | content % | (mbar) |
| **BTWLN | +/+/+ | 49 ± 2 | 8.4 ± 7 | 72 | |
| T₀ | +/+/+ | 24 ± 7 | 8.0 ± 7.5 | 72 | 1000 |
| T₄ | NDA | NDA | NDA | 25 | 0.398 |
| T₆ | 24 ± 1 | — | 7.0 ± 5.7 | 7.5 | 0.200 |

Key for all following tables:
*Counts are for 0.1 ml sample with 5-fold dilution factor (2.5 g meat + 10 ml saline), at the given dilution.
**c.f.u.—colony forming units.
***BTWLN = Before treating with liquid nitrogen.
+/+/+ = too numerous to count
NDA = No data available

TABLE 2
S. aureus population, moisture content and pressure at 70° C.
within 6 hrs of freeze drying

| | Dilutions: | | | | |
|---|---|---|---|---|---|
| | | Count | | | |
| | | at 10⁻⁵ | | | |
| | | dilution | Log | | |
| Sample | Count at | (Average ± | c.f.u./g | Moisture | Pressure |
| point | 10⁻⁴ dilution | SD) | of meat | content % | (mbar) |
| BTWLN | +/+/+ | 131 ± 23 | 8.8 ± 8.0 | 70 | |
| T₀ | +/+/+ | 52 ± 10 | 8.4 ± 7.7 | 70 | 1000 |
| T₂ | +/+/+ | 170 ± 16 | 8.9 ± 7.9 | 35 | 2 |
| T₄ | +/+/+ | 105 ± 25 | 8.7 ± 8.0 | 13 | 1 |
| T₆ | 8/4/12 | 2 ± 1 | 6.6 ± 6.3 | 3 | 1 |

TABLE 3
S. aureus population, moisture content and pressure at 80° C.
within 6 hrs of freeze drying

| | Dilutions: | | | | |
|---|---|---|---|---|---|
| | | Count | | | |
| | | at 10⁻⁵ | | | |
| | Count at | dilution | Log | | |
| Sample | 10⁻⁴ | (Average ± | c.f.u./g | Moisture | Pressure |
| point | dilution | SD) | of meat | content % | (mbar) |
| BTWLN | +/+/+ | 33 ± 10 | 8.2 ± 7.6 | 71 | |
| T₀ | +/+/+ | 18 ± 2 | 7.9 ± 7.0 | 71 | 1000 |
| T₂ | +/+/+ | 17 ± 9 | 7.9 ± 7.6 | 38 | 1.585 |
| T₄ | +/+/+ | 14 ± 2 | 7.8 ± 7.0 | 15 | 1.7 |
| T₆ | 46 ± 38 | 5 ± 4 | 7.3 ± 7.3 | 4 | 0.397 |

TABLE 4
B. subtilus population, moisture content and pressure at 70° C.
within 5 hrs of freeze drying

| | Dilutions: | | | | |
|---|---|---|---|---|---|
| | | Counta t 10⁻⁵ | | | |
| | Count at | dilution | Log | | |
| Sample | 10⁻⁴ | (Average ± | c.f.u./g | Moisture | Pressure |
| point | dilution | SD) | of meat | content % | (mbar) |
| BTWLN | +/+/+ | 163 ± 15 | 8.9 ± 7.8 | 70 | |
| T₀ | +/+/+ | 98 ± 14 | 8.7 ± 7.8 | 70 | 1000 |
| T₂ | +/+/+ | 39 ± 31 | 8.7 ± 8.2 | 36 | NDA |
| T₄ | +/+/+ | 37 ± 7 | 8.3 ± 7.5 | 24 | NDA |
| T₅ | 13 ± 7 | 3 ± 2 | 7.1 ± 7.0 | 7 | NDA |

In a final experiment, the vacuum was released at each sampling point, and the meat within the freeze dryer left at atmospheric pressure for 15-25 minutes (the “dwell time”) before re-applying the vacuum. The results for this experiment were as follows:

TABLE 5
B. subtilus population, moisture content and pressure at 60° C.
within 6 hrs of freeze drying

| | Dilutions: | | | | | |
|---|---|---|---|---|---|---|
| | | | Count at 10⁻⁵ | | | |
| | Dwell | | dilution | Log | | |
| Sample | Time | Count at | (Average ± | c.f.u./g | Moisture | Pressure |
| point | (min) | 10⁻⁴ dilution | SD) | of meat | content % | (mbar) |
| BTWLN | | +/+/+ | 85 ± 8 | 8.6 ± 7.6 | 70 | |
| T₀ | | +/+/+ | 54 ± 30 | 8.4 ± 8.1 | 40 | 1000 |
| T₁ | 15 | 7 ± 3 | 1 ± 0 | 6.5 ± 6.2 | 25 | 0.158 |
| T₂ | 20 | 4 ± 1 | 0/0/0 | 6.3 ± 5.7 | 20 | 1.2 |
| T₃ | 25 | 3 ± 2 | 0/0/0 | 6.2 ± 6.0 | 6 | 0.6 |
| T₄ | | 4 ± 4 | 0/0/0 | 6.3 ± 6.3 | 5 | 0.2 |

It can be seen from the results that significantly improved inactivation of the micro-organisms occurred when an increased dwell time was employed (i.e. for at least 5 minutes). Microbial inactivation was also enhanced once the moisture content of the meat was reduced below 25%.

Treating the samples with liquid nitrogen appears to bring the bacterial population to approximately 50% of its original population. The inventors believe that the increase in pressure from (0.158-2) mbar to 1000 mbar within few seconds (i.e. the release of the partial vacuum) causes a lethal pressure stress. Previous indications were that it is the effect of a freeze-thaw cycle that results in significant microbial inactivation, but the results indicate that a brief dwell time (even the 1 minute allowed for sampling) which is not enough for thawing can still cause a microbial reduction. Moisture content also plays a key role in microbial population reduction. Whilst microbial population reduction is not considerable at T₄, at T₆ there is 10-fold eradication in comparison with T₀.

It is believed that high level of moisture content can act as a shield to protect microbes against pressure stress. Once moisture content reaches to a certain level (25%), the combination of osmotic and pressure stresses has an enhanced lethal effect. Following any such process herein described is an optional stage of sterilisation of the “dry fines” so produced. Depending on the application and the required standards of sterility the dry fines may be subjected to a further heat treatment, a treatment with a chemical sterilant such as ozone, or treatment with ionising radiation.

Following reduction of the carcass to a small particle size dried product, it may be buried in soil.

The inventors have found, however, that combining the dried, or partially-dried end product with a biodegradable high-carbon, low nitrogen material such as wood chippings, starch, cellulose, waste paper or cardboard, or generally high molecular weight, complex polysaccharides, significantly enhances the degradation of the material, either following burial, or in a further composting process. Particular benefits include an increase in speed of degradation and a reduction in odour production. Additional of such material at a rate of at least 5%, and preferably more than 10% based on the initial weight of the remains is preferred.

Accelerated composting may be carried out by mixing the processed remains with such a high-carbon material and periodically aerating the mixture by the use, e.g. of a rotating drum composter.

In alternative arrangements, the dried processed remains may be used as fuel for power generation.

1. A method of treating organic remains comprising the steps of:
(a) freezing said remains to a temperature of below −180° Celsius;
(b) size-reducing said remains to produce a size-reduced fraction having a particle size of less than 10 mm;
(c) exposing said frozen size-reduced fraction to a partial vacuum, having a pressure of below 1 kPa;
(d) heating said size-reduced fraction in said partial vacuum, removing water therefrom;
(e) releasing said partial vacuum; and
(f) repeating steps (c) to (e).

2. The method of claim 1, wherein said partial vacuum has a pressure of below 0.1 kPa.

3. A method according to claim 1 wherein, in step (d), said fraction is heated to a temperature above 50° Celsius.

4. The method of claim 3 wherein said fraction is heated to a temperature of between 50° and 60° Celsius.

5. A method according to claim 1, having released said partial vacuum at step (e), said remains are held at such increased pressure for at least 5 minutes before re-exposure to partial vacuum.

6. A method according to claim 1 wherein the size reduction of step (b) produces a particle size of less than 2 mm.

7. A method for treating organic remains containing non-organic material comprising a method according to any preceding claim preceded by further steps of:
(i) freezing said remains to a temperature of below −40° Celsius;
(ii) size-reducing said remains to produce a coarsely-size-reduced fraction having a size of less than 100 mm; and
(iii) removing non-organic material from said coarsely-size-reduced fraction.

8. A method of treating organic remains substantially as described herein, with reference to and as illustrated by any appropriate combination of the accompanying drawings.

9. Apparatus configured to carry out a method according to claim 1.

10. A method of disposing of human cadavers comprising the steps of treating the cadavers by a method according to claim 1.

11. A method according to claim 10, further comprising the step of adding a high-carbon, low nitrogen complex polysaccharide to said treated cadavers, and allowing said mixture to decompose.
